(19) United States
(12) Patent Application Publication
(10) Pub. No.: US 2003/0175565 A1
(43) Pub. Date: Sep. 18, 2003

(54) Solid oxide fuel cell system and a method for controlling the same

(75) Inventor: Yasuo Noda, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/367,872

(22) Filed: Feb. 19, 2003

(30) Foreign Application Priority Data
Feb. 19, 2002 (JP) 2002-042123

(51) Int. Cl. H01M 8/18; H01M 8/12; H01M 8/04

(52) U.S. Cl. 429/21; 429/30; 429/24

(57) ABSTRACT

A solid oxide fuel cell system includes an electrochemical processing unit and a solid oxide fuel cell having an electricity generating unit. The electrochemical processing unit includes a first solid oxide electrolyte, a first electrode, a first fuel passage supplying fuel to the first electrode, a second electrode, a first oxidant passage for supplying oxidant to the second electrode, and a power source unit capable of applying an electric potential to between the first electrode and the second electrode so as to positively charge the first electrode. The electricity generating unit includes a second solid oxide electrolyte, an anode, a second fuel passage, a cathode, and a second oxidant passage. The fuel emitted from the first fuel passage is supplied to the second fuel passage.

### CROSS REFERENCE TO RELATED APPLICATIONS

This application is based on and claims priority under 35 U.S.C. §119 with respect to a Japanese Patent Application 2002-042123, filed on Feb. 19, 2002, the entire content of which is incorporated herein by reference.

### FIELD OF THE INVENTION

This invention generally relates to a solid oxide fuel cell system and a method for controlling the same.

### BACKGROUND OF THE INVENTION

A solid oxide fuel cell (hereinafter, referred to as an SOFC) is highly expected in respect to possessing a high electricity generating efficiency, no need to be provided with a highly cost precious metal as an electrode catalyst, being capable of utilizing a wide variety of fuels. The SOFC, however, has not been come into wide use due to some tasks to be solved, for example in that the SOFC operates at a relatively high temperature so that heat loss may be increased, and it may take long time for staring-up the SOFC and shutting down the same.

U.S. Pat. No. 6,033,794 (hereinafter, referred to as a first conventional work) discloses a multi-stage fuel cell system, in which a low temperature fuel cell, such as a molten carbonate fuel cell or a low temperature SOFC, having an operating temperature around 500° C. is arranged alongside an intermediate temperature fuel cell or a high temperature fuel cell such as the SOFC, so as to inhibit the heat loss. Therefore, a thermal design applied for the disclosed multi-stage fuel cell system can be effectively performed.

A Japanese Patent Laid-open published as No. 08(1996)-306369 (hereinafter, referred to as a second conventional work) discloses another fuel cell system optimizing one of the characteristics of the SOFC that can convert the energy in the fuel containing hydrogen molecules and carbon monoxide into electricity. The disclosed fuel cell system includes the SOFC consuming the carbon monoxide and a polymer electrolyte fuel cell (hereinafter, referred to as a PEFC), which is arranged behind the SOFC and optimizes the hydrogen molecules.

Further, a system enabling to downsize the SOFC and to cut down a time period for starting-up the system has been proposed with recent approaches to apply the SOFC to a movable body such as an automobile. For example, pages 530 through 533 of a publication entitled “Development of a Solid Oxide Fuel Cell (SOFC) Automotive Auxiliary Power Unit (APU) Fueled by Gasoline” (2000 Fuel Cell Seminar) (hereinafter, referred to as a third conventional work) proposes an auxiliary power line SOFC for an automobile which reforms gasoline by use of a simple and compact reformer unit.

Meantime, recent studies have led to a fuel cell possessing an internal reforming method for reforming directly supplied hydrocarbon-containing fuel with no use of the reformer unit. However, this type of fuel cell has still some difficulties to be utilized until solving a problem that carbon is deposited around a fuel inlet of an anode. U.S. Pat. No. 6,214,485 (hereinafter, referred to as a fourth conventional work) discloses a direct hydrocarbon fuel cell which directly reforms the hydrocarbon-containing fuel by the SOFS, which was directly supplied thereto. The SOFC is provided with a partially reforming catalyst for inhibiting the carbon from being deposited around the fuel inlet of the anode, thereby solving the problem that the carbon is deposited. The disclosed SOFC without a reformer unit is highly expected to achieve a simple fuel cell system and a shortened period of start-up concurrently.

Although the fuel systems according to the first and second conventional works are configured optimizing the characteristics of each type of fuel cell, the system may be complex and up-sized, thereby the disclosed fuel systems may not be able to control start-up and shut down performance of the system as effectively as a system possessing a single type of fuel cell. The SOFC according to the third conventional work is associated with the reformer unit being separated from the SOFC so that the fuel cell operates even after the automobile is stopped. Accordingly, a long time period may be required to control the start-up and shut down operation in the same manner as the first and second conventional works. The SOFC according to the fourth conventional work directly reforms the fuel in the fuel cell without using the reformer unit so that the time period of start-up can be cut down. However, the SOFC is provided with the partially reforming catalyst for inhibiting the carbon from being deposited so that the endurance of the SOFC may be deteriorated and the manufacturing cost thereof may be increased.

The present invention therefore seeks to provide an improved solid oxide fuel cell system capable of being downsized and cutting down the start-up and shut down periods and to provide a method for controlling the improved solid oxide fuel cell system.

### SUMMARY OF THE INVENTION

According to an aspect of the present invention, a solid oxide fuel cell system includes an electrochemical processing unit and a solid oxide fuel cell. The electrochemical processing unit includes a first solid oxide electrolyte, a first electrode defined at one side of the first solid oxide electrolyte, a first fuel passage for supplying fuel to the first electrode, a second electrode defined at the other side of the first solid oxide electrolyte, a first oxidant passage for supplying oxidant to the second electrode, and a power source unit capable of applying an electric potential to between the first electrode and the second electrode so as to positively charge the first electrode. A solid oxide fuel cell having an electricity generating unit includes a second solid oxide electrolyte, an anode defined at one side of the second solid oxide electrolyte, a second fuel passage supplying the fuel to the anode, a cathode defined at the other side of the second solid oxide electrolyte, and a second oxidant passage for supplying the oxidant to the cathode. The fuel emitted from the first fuel passage is supplied to the second fuel passage.

According to another aspect of the present invention, the solid oxide fuel cell is provided with plural electricity generating units. The electricity generating unit positioned at an upstream side for the fuel supply operates at a lower temperature than the electricity generating unit positioned at a downstream side for the fuel supply.

According to still another aspect of the present invention, a mixing portion is disposed between the plural electricity generating units for mixing gas emitted from plural cells in the electricity generating unit positioned at the upstream side and for supplying the mixed gas to the electricity generating unit positioned at the downstream for the fuel cell.

### BRIEF DESCRIPTION OF THE DRAWING FIGURES

The foregoing and additional features and characteristics of the present invention will become more apparent from the following detailed description considered with reference to the accompanying drawing figures wherein:

FIG. 1 is a conceptual view schematically illustrating an entire solid oxide fuel cell (SOFC) system according to embodiments of the present invention;

FIG. 2 is a cross-sectional view schematically illustrating the SOFO system according to the first embodiment;

FIG. 3 is an explanatory view schematically illustrating an electrochemical processing unit and a low temperature SOFC unit according to the first embodiment;

FIG. 4 is an explanatory view schematically illustrating a high temperature SOFC unit according to the first embodiment;

FIG. 5 is a perspective view schematically illustrating the SOFC system according to the second embodiment;

FIG. 6 is a view illustrating a partial cross sectional view taken along a line orthogonal with a fuel supply direction of a low temperature SOFC unit according to the second embodiment;

FIG. 7 is a cross sectional view schematically illustrating a first gas mixing portion 88, a second gas mixing portion 89, and adjacent portions thereto according to the second embodiment;

FIG. 8 is a flow chart explaining a start-up operation of the SOFC system according to the first and second embodiments; and

FIG. 9 is a flow chart explaining a shut-down operation of the SOFC system according to the first and second embodiments.

### DETAILED DESCRIPTION OF THE INVENTION

A fuel cell system according to embodiments of the present invention optimizes characteristics of a solid oxide fuel cell (hereinafter, referred to as an SOFC), in that the SOFC can generate electricity with high efficiency, can internally reform a wide variety of fuels, and can utilize the reformed fuel. The fuel cell system includes an internally reforming method for reforming the fuel without using a reformer unit. The fuels employed according to the embodiments of the present invention include hydrocarbon-containing fuel, alcohols fuel, and so on.

Typical reactions taking place at an anode side of the fuel cell supplied with methane as the fuel are:

CH₄→C+2H₂ (cracking reaction) (1-1)

CH₄+O²⁻→2H₂+CO+2e⁻ (partially oxidizing reaction) (1-2)

H₂+O²⁻→H₂O+2e⁻ (electricity generating reaction) (1-3)

CO+O²⁻→CO₂+2e⁻ (electricity generating reaction) (1-4)

CH₄+H₂O→3H₂+CO (reforming reaction) (1-5)

CH₄+CO₂→2H₂+2CO (reforming reaction) (1-6).

Typical reactions taking place at the anode side of the fuel cell supplied with decalin as the fuel are:

C₁₀H₁₈→C₁₀H₈+5H₂ (cracking reaction ) (2-1)

C₁₀H₈→C₆H₆+4C+4H₂ (cracking reaction) (2-2)

C₆H₆→6C+3H₂ (cracking reaction) (2-3)

C₁₀H₈+10O²⁻→4H₂+10CO+2e⁻ (partially oxidizing reaction) (2-4)

H₂+O²⁻→H₂O+2e⁻ (electricity generating reaction) (2-5)

CO+O²⁻→CO₂+2e⁻ (electricity generating reaction) (2-6)

C₁₀H₁₈+10H₂O→19H₂+10CO (reforming reaction) (2-7)

C₁₀H₈+10H₂O→14H₂+10CO (reforming reaction) (2-8)

C₁₀H₁₈+10CO₂→9H₂+20CO (reforming reaction) (2-9)

C₁₀H₈+10CO₂→4H₂+20CO (reforming reaction) (2-10).

Typical reactions taking place at the anode side of the fuel cell supplied with methanol as the fuel are:

CH₃OH→CO+2H₂ (cracking reaction) (3-1)

2CH₃OH→C+CO+H₂O+3H₂ (cracking reaction) (3-2)

CH₃OH+O₂→CO₂+H₂O+H₂ (partially oxidizing reaction) (3-3)

H₂+O²⁻→H₂O+2e⁻ (electricity generating reaction) (3-4)

CO+O²⁻CO₂+2e⁻ (electricity generating reaction) (3-5)

CH₃OH+CO₂→H₂+H₂O+2CO (reforming reaction) (3-6)

CH₃OH+2H₂O+CO→4H₂+2CO₂ (reforming reaction) (3-7).

Typical reactions taking place at the anode side of the fuel cell supplied with dimenthyl ether as the fuel are:

CH₃OCH₃→C+CO+6H₂ (cracking reaction) (4-1)

C+CO+6H₂+O2→5H₂+2CO+H₂O (partially oxidizing reaction) (4-2)

H₂+O²⁻→H₂O+2e⁻ (electricity generating reaction) (4-3)

CO+O²⁻→CO₂+2e⁻ (electricity generating reaction) (4-4)

CH₃OCH₃+CO₂→5H₂+H₂O+2CO (reforming reaction) (4-5)

CH₃OCH₃+H₂O→7H₂+2CO (reforming reaction) (4-6).

Whichever fuel is supplied to the fuel cell, as explained as the reaction formulas (1-1), (2-2), (2-3), (3-2), (4-1), hydrogen, bonds are dissociated at a relatively low temperature range and carbon is generated in accordance with the cracking reaction. The carbon reacts with moisture vapor (H₂O) or oxygen (O₂) and is internally reformed at a relatively high temperature range so as to generate hydrogen molecules (H₂) and carbonic acid gas such as carbon monoxide (CO), carbon dioxide (CO₂). The fuel cracking reaction is predominantly activated around the anode fuel inlet at the relatively low temperature so that the carbon generated in accordance with the cracking reaction is deposited onto the anode. Therefore, the electricity generating reaction is inhibited at the anode due to the carbon deposition and the electricity generation efficiency of the fuel cell may be deteriorated.

The problem of the carbon deposition onto the anode is solved by the following methods according to the present invention. A solid oxide electrolyte adjacent a fuel cell inlet, of which temperature widely drops due to the fuel cracking reaction, is applied with voltage from an outside so that the fuel cell is internally heated up. Further, the voltage apply to the solid oxide electrolyte promotes oxygen ion (O²⁻) in the solid oxide electrolyte to be diffused onto the anode side. Therefore, the solid oxide electrolyte according to the embodiments of the present invention functions to oxidize the carbon prior to the carbon deposition onto the anode fuel inlet.

The solid oxide electrolyte of the SOFC includes an oxide possessing a property for diffusing the oxygen ion therein. The oxygen ion is diffused to the anode when the solid oxide electrolyte is externally applied with an electrically exciting operation. The carbon (C) deposited onto the anode side is oxidized with the oxygen ion (O²⁻) diffused to the anode and is emitted as the carbon monoxide (CO). Further, the solid oxide electrolyte generates heat by an internal resistance of the solid oxide electrolyte in response to the electrically exciting operation thereof and is easily heated up to approximately 500° C. or greater than that. In this case, the temperature of the solid oxide electrolyte meets the temperature conditions of a low temperature SOFC for generating electricity. The aforementioned SOFC with the internal reforming method can ensure enough electricity generation efficiency to be practically used. Therefore, the SOFC system according to the embodiments of the present invention can be effectively downsized without being provided with devices such as a reformer unit. Further, the SOFC system according to the embodiments of the present invention can increase the temperature of the solid oxide electrolyte up to a temperature level at which the SOFC can generate electricity at an early stage so that a time period of start-up can be effectively improved. Still furthermore, the SOFO system does not require a separated reformer unit. Therefore, only unburned fuel in the fuel cell react with oxygen via the solid oxide electrolyte for generating electricity. The SOFC can be stopped after the electricity generation, thereby a period of shut down can be effectively shortened.

As described above, the vapor and the carbonic acid gas are discharged as they as at the relatively low temperature range. However, as explained by the reaction formulas (1-5), (1-6), (2-7) through (2-10), (3-6), (3-7), (4-5), and (4-6), hydrogen molecules (H2) and carbonic acid gas are generated in accordance with the reforming reaction and the hydrogen molecules can be utilized for electricity generation, thereby the electricity generating efficiency of the SOFC can be further improved. That is, the SOFC system is provided with a low temperature unit SOFC and a high temperature unit SOFC, in which the fuel is supplied to the low temperature unit SOFC and gas emitted from the low temperature unit SOFC is supplied to the high temperature unit SOFO, wherein the time period for starting-up the system can be effectively cut down and the electricity generating efficiency can be effectively improved.

Although the low and high temperature ranges are varied depending on the employed fuels, the low temperature range represents a temperature range, in which the cracking reaction is predominantly activated, and the high temperature range represents a temperature range, in which the reforming reaction is predominantly activated. For example, when the SOFC is supplied with the fuel such as methane, decalin, dimenthyl ether, or the like, the low temperature represents a temperature being approximately equal to or lower than 400° C. and the high temperature represents a temperature being approximately equal to or greater than 500° C. When the SOFC is supplied with methanol as the fuel, the low temperature represents a temperature being approximately equal to or lower than 300° C. and the high temperature represents a temperature being approximately equal to or greater than 350° C.

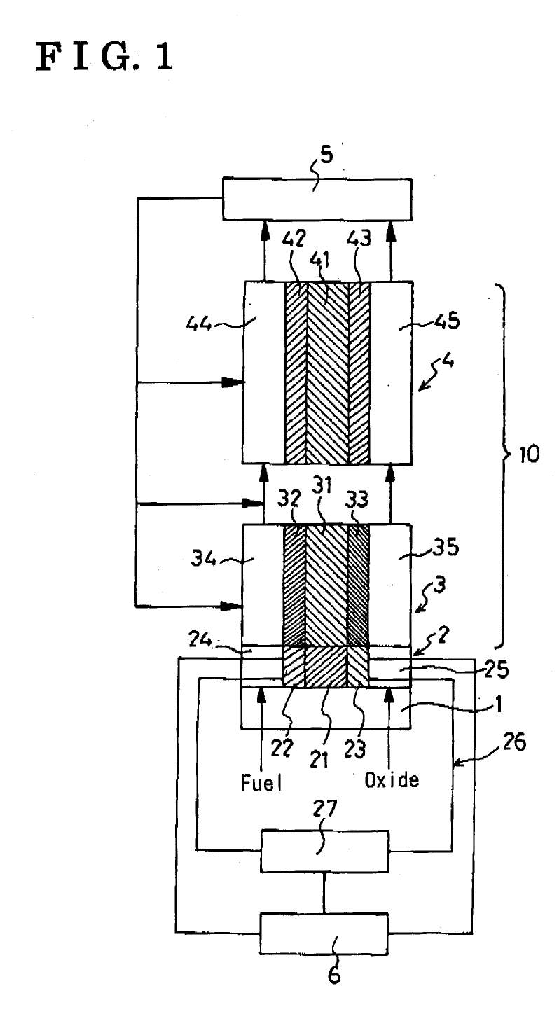

As especially seen in FIG. 1, the SOFC system according to the embodiments of the present invention is provided with a preheating unit 1, an electrochemical processing unit 2, a low temperature SOFC unit 3, a high temperature SOFC unit 4, an offgas combustor 5, a power source unit 6, a carbon deposition detecting unit 26, and a control unit 27.

The low temperature SOFC unit 3 and the high temperature SOFC unit 4 are electricity generating units of a solid oxide fuel cell 10 (hereinafter referred to as an SOFC), respectively. The low temperature SOFC unit 3 is provided with a second solid oxide electrolyte 31, an anode 32, a cathode 33, a second fuel passage 34, and a second oxidant passage 35. The high temperature SOFC unit 4 is provided with a second solid oxide electrolyte 41, an anode 42, a cathode 43, a second fuel passage 44, and a second oxidant passage 45. The anode 32 is defined at one side of the second solid oxide electrolyte 31 and the cathode 33 is defined at the other side thereof. The second fuel passage 34 functions for supplying the fuel to the anode 32 and the second oxidant passage 35 functions for supplying the oxidant to the cathode 33. The anode 42 is defined at one side of the second solid oxide electrolyte 41 and the cathode 43 is defined at the other side thereof. The second fuel passage 44 functions for supplying the fuel to the anode 42 and the second oxidant passage 45 functions for supplying the oxidant to the cathode 43.

The second solid oxidant electrolyte 31 of the low temperature SOFC unit 3 is made of solid oxide material which possesses oxygen ionic conductivity and operates in a relatively low temperature range of between about 500° C. and about 800° C. The typical solid oxide electrolyte includes a ceria-rare earth metal oxide (e.g. (CeO₂)_{0.8}(SmO_{1.5})_{0.2}), La_{0.9}Sr_{0.1}Mg_{0.2}Ga_{0.8}O₃, Ce_{0.8}Gd_{0.2}O_{1.9} membrane, stabilized zirconia oxide membrane, and so on. The second solid oxide electrolyte 41 for the high temperature SOFC unit 4 is also made of solid oxide material which possesses oxygen ionic conductivity and yet operates in a The typical solid oxide material includes stabilized zirconia such as yttria-stabilized zirconia (YSZ) and scandium stabilized zirconia (ScSZ)), and so on.

The electrochemical processing unit 2 is provided with a first solid oxide electrolyte 21, a first electrode 22, a second electrode 23, a first fuel passage 24, and a first oxidant passage 25. The first electrode 22 is defined at one side of the first solid oxide electrolyte 21 and tire second electrode 23 is defined at the other side thereof. The first fuel passage 24 functions for supplying the fuel to the first electrode 22 and the first oxidant passage 25 functions for supplying the oxidant to the second electrode 23. An electric potential can be applied to between the first electrode 22 and the second electrode 23 by the power source unit 6 so as to positively charging the first electrode 22. The first solid oxide electrolyte 21 is made of solid oxide material which possess oxygen ionic conductivity and operates at a relatively low temperature range, thereby capable of cuttingdown the time period of start-up.

The electrodes 22 and 23 are electrically connected to the control unit 27 by means of signal wires, respectively. The control unit 27 is electrically connected to the power source unit 6 via a signal wire. The carbon deposition detecting unit 26 detects the carbon deposition onto the first electrode 22 by cutting off voltage being applied to the first electrode 22 and the second electrode 23 by the control unit 27 and by detecting an actual voltage under a constant load resistance applied to the first and second electrodes 22 and 23. The voltage is applied to the electrodes 22 and 23 by the power source unit 6. The carbon deposition detecting unit is not limited to the configuration described above as far as being able to detect the carbon deposition onto the first electrode 22. The control unit 27 also controls the SOFC system itself.

The electrochemical processing unit 2 is arranged adjacent to the low temperature SOFC unit 3 and the fuel and the oxidant can be supplied to the low temperature SOFC unit 3 via the electrochemical processing unit 2. The fuel and the oxidant supplied to the low temperature SOFC unit 3 is consumed for generating electricity, and yet residual fuel and oxidant are supplied to the high temperature SOFC unit 4. That is, the electrochemical processing unit 2 is arranged adjacent to the SOFC 10 and the fuel and the oxidant are supplied to the SOFC 10 via the electrochemical processing unit 2.

The preheating unit 1 is a burner for heating the fuel and the oxidant to be supplied to the electrochemical processing unit 2, which is arranged adjacent to the electrochemical processing unit 2. Offgas emitted from the high temperature SOFC unit 4 is supplied to the offgas combustor 5. The fuel remaining in the offgas is combusted by the offgas combustor 5 and is circulated to both SOFCs units 3 and 4 as exhaust gas. The exhaust gas heats up each SOFC unit 3 and 4 so as to maintain the units 3 and 3 at a preferable operating temperature.

Although not being illustrated, an electric wire connected to the anode 32 and the cathode 33 of the low temperature SOFC unit 3, respectively so as to transfer electricity generated at the low temperature SOFC unit 3 to the outside. The first electrode 22 and the anode 32 are electrically insulated and the second electrode 23 and the cathode 33 are also electrically insulated.

Fist of all, the preheating unit 1 is ignited. The fuel for use of the burner can be for use of the fuel cell and also can be for other uses. The preheating unit 1 possesses a heat exchanging mechanism for preheating the fuel and the oxidant to be supplied to the SOFC 10 by the combustion heat of the preheating unit 1. The heat exchanging mechanism of the preheating unit 1 further functions for heat-exchanging the heat of the exhaust gas emitted from the offgas combustor 5. The combustion heat of the preheating unit 1 can also preheat the electrochemical processing unit 2 and increase the temperature thereof.

The fuel and the oxidant are both preheated by the preheating unit 1 and are supplied to the first fuel passage 24 and the first oxidant passage 25, respectively. The electric potential is applied to between the first electrode 22 and the second electrode 23 for positively charging the first electrode 22. The electrochemical processing unit 2 is heated with the heat of the fuel and the oxidant both supplied thereto and is also directly heated by the combustion heat of the preheating unit 1. Ionic conduction is activated via the first solid oxide electrolyte 21 applied with the electric potential and heat is then generated in response to the ionic conduction and the increase of the temperature of the electrochemical processing unit 2. Although the internal temperature of the first solid oxide electrolyte 21 can not be increased at a preferable stage only when being applied with the heat of the fuel and the oxidant and the heat of the preheating unit 1, the internal temperature thereof can be increased at an early stage when being applied with Joule heat generated by the electric potential apply to the electrolyte 21. The oxygen ion is diffused via the first solid oxide electrolyte 21 from the second electrode 23 to the first electrode 22 by applying the electric potential to between the first electrode 22 and the second electrode 23 when the actual temperature of the first solid oxide electrolyte 21 approximates the operating temperature thereof. The oxygen ion (O²⁻) diffused to the first electrode 22 reacts with the carbon (C) generated by the fuel cracking reaction in the first fuel passage 24 and converts to carbon monoxide gas (CO). The carbon monoxide gas (CO) is supplied to the second fuel passage 34 of the low temperature SOFC unit 3 with hydrogen molecules (H₂) generated by the cracking reaction. Although the cracking reaction is predominantly activated at the electrochemical processing unit 2, the partially oxidizing reaction is also activated. Especially when the oxygen ion (O²⁻) reacts with the carbon (C), the partially oxidizing reaction is slightly activated. As described above, the SOFC system according to the embodiments of the present invention is not required to possess a reforming unit so that the system can be downsized.

The electricity generating reaction is activated at the low temperature SOFC unit 3 by use of the hydrogen molecules and the carbon monoxide contained in the fuel supplied to the second fuel passage 34 and the oxygen in the oxidant (generally air) supplied to the second oxidant passage 35. The electricity generated in accordance with the electricity generating reaction is supplied to an external equipment. The cracking reaction, the partially oxidizing reaction, and the reforming reaction are concurrently activated at the second fuel passage 34 so that the hydrogen molecules and the carbon monoxide are generated from the fuel which could not react at the electrochemical processing unit 2. The hydrogen molecules and the carbon monoxide are partially consumed at the low temperature SOFC unit 3 and are also partially supplied to the second fuel passage 44 of the high temperature SOFC unit 4. The carbon (C) generated by the cracking reaction is bonded with the oxygen (O₂) in response to the oxygen ion conduction corresponding to the electricity generation and is converted to the carbon monoxide (CO) for the use of the electricity generating reaction.

The electricity generating reaction is activated at the high temperature SOFC unit 4 by use of the hydrogen molecules and the carbon monoxide contained in the fuel supplied to the second fuel passage 44 and the oxygen contained in the oxidant supplied to the second oxidant passage 45. The generated electricity is supplied to the external equipment. The second fuel passage 44 is supplied with not only the hydrogen molecules and the carbon monoxide, which were not consumed at the low temperature SOFC unit 3, but also fuel which could not been burnt at the electrochemical processing unit 2 and the low temperature SOFC unit 3, vapor and carbon dioxide gas, both of which were generated by the electricity generating reaction. As described above, the temperature of the second fuel passage 44 has been sufficiently increased by the internal heating operation in accordance with the electricity generating reaction and the external heating operation in accordance with the offgas combustion so that the nonreacted fuel reacts with the vapor or the carbonic acid gas and is reformed as hydrogen molecules (H₂) and carbon monoxide (CO) in accordance with the reforming reaction. The hydrogen molecules (H₂) and the carbon monoxide (CO) are utilized for the electricity generating reaction. The high temperature SOFC unit 4 can be supplied with water as a result of the electricity generating reaction so that there is no need to be supplied with water from an external device.

The fuel offgas emitted from the second fuel passage 44 and the oxidant offgas emitted from the second oxidant passage 45 are supplied to the offgas combustor 5. Combustible gas remaining in the fuel offgas is combusted at the offgas combustor 5 with the oxygen remaining in the oxidant offgas and the exhaust gas from the offgas combustor 5 is circulated to the low temperature SOFC unit 3 and the high temperature SOFC unit 4 so as to heat up the low temperature SOFC unit 3 and the high temperature SOFC unit 4. In this case, a well-known heat exchanging mechanism is adopted for heating up the units 3 and 4 by the exhaust gas. The temperature of each SOFC unit 3 and 4 is maintained at a preferable temperature by means of a non-illustrated control unit and a non-illustrated valve. Especially when the system is started-up, each temperature of the low temperature SOFC unit 3 and the high temperature SOFC unit 4 is not sufficiently high for activating the reforming reaction and the electricity generating reaction. In this case, the nonreacted fuel is supplied to the offgas combustor 5 and is combusted at a high combustion heat. Therefore, each SOFC unit 3 and 4 can be rapidly heated up and the time period of start-up can be effectively cut down. Especially when methane is adopted as the fuel, which is cracked at a relatively high temperature, the large amount of non-reacted methane can be supplied to the high temperature SOFC unit 4.

The actual temperature of the electrochemical processing unit 2 reaches a predetermined temperature under a stationary state. In this case, there is not much concern that the carbon generated by the cracking reaction is deposited. Therefore, electrical power consumption can be effectively economized by canceling the electric, potential apply to the electrochemical processing unit 2. However, the carbon deposition may occur while the electrochemical processing unit 2 has operated for a long time. When the carbon deposition is detected by the carbon deposition detecting unit 26, the electric potential is applied to the electrochemical processing unit 2 by the power resource unit 6 in response to the command signal from the control unit 27 so that the carbon (C) is oxidized and is emitted as the carbon monoxide (CO). As described above, the carbon deposition can be effectively inhibited. Further, the temperature of the SOFC system can be increased at an earlier stage in favor of heat generation in accordance with this oxidizing reaction. On the other hand, when the carbon deposition is not detected by the carbon deposition detecting unit 26, the apply of the electric potential to the electrochemical processing unit 2 is cancelled.

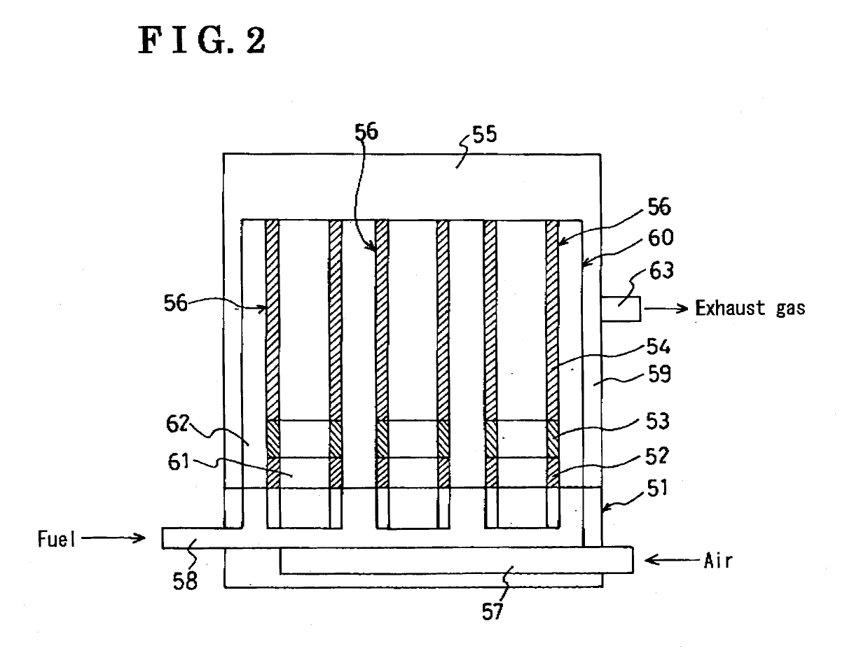

As illustrated in FIG. 2, the SOFC system according to the first embodiment of the present invention includes a preheating unit 51, an electrochemical processing unit 52, a low temperature SOFC unit 53, a high temperature SOFC unit 54, and an offgas combustor 55. The electrochemical processing unit 52, the low temperature SOFC unit 53, and the high temperature SOFC unit 54 are formed with approximately cylindrical solid oxide electrolytes, respectively. As described later, the electrochemical processing unit 52 and the low temperature SOFC unit 53 are provided with a common low temperature electrolyte and the high temperature SOFC unit 54 is provided with a high temperature electrolyte. Internal and external diameters of the low temperature electrolyte are substantially the same as the internal and external diameters of the high temperature electrolyte. These two electrolytes are bonded with each other via an insulator.

As especially seen in FIG. 2, a fuel cell 60 according to the first embodiment of the present invention is formed with plural cylindrical portions 56, each of which is consisted of the electrochemical processing unit 52, the low temperature SOFC unit 53, and the high temperature SOFC unit 54. An oxidant passage 61 is defined at an inner peripheral side of the cylindrical portion 56 and functions as a first oxidant passage of the electrochemical processing unit 52, a second oxidant passage of the low temperature SOFC unit 53, and a second oxidant passage of the high temperature SOFC unit 54. A fuel passage 62 is defined at an outer peripheral side of the cylindrical portion 56 in the fuel cell 60 and functions as a first fuel passage of the electrochemical processing unit 52, a second fuel passage of the low temperature SOFC unit 53, and a second fuel passage of the high temperature SOFC unit 54.

The preheating unit 51 is arranged adjacent the low temperature SOFC unit 53. An oxidant supply conduit 57 and a fuel supply conduit 58 are structurally connected to the oxidant passage 61 and the fuel passage 62 via the preheating unit 51, respectively. An outlet of the preheating unit 51 is structurally connected to an exhaust gas passage 59 which is equipped at an outer surface of the fuel cell 60. Outlets of the oxidant passage 61 and the fuel passage 62 communicate with the offgas combustor 55 and an outlet of the offgas combustor 55 communicates with the exhaust gas passage 59. The exhaust gas passage 59 functions as an exhaust gas passage of the preheating unit 51 as well and is provided with an exhaust gas emitting portion 63 at an appropriate position thereof. The equipped position of the exhaust gas emitting portion 63 is determined based upon the shape of the SOFC system, the system operating conditions, or the like.

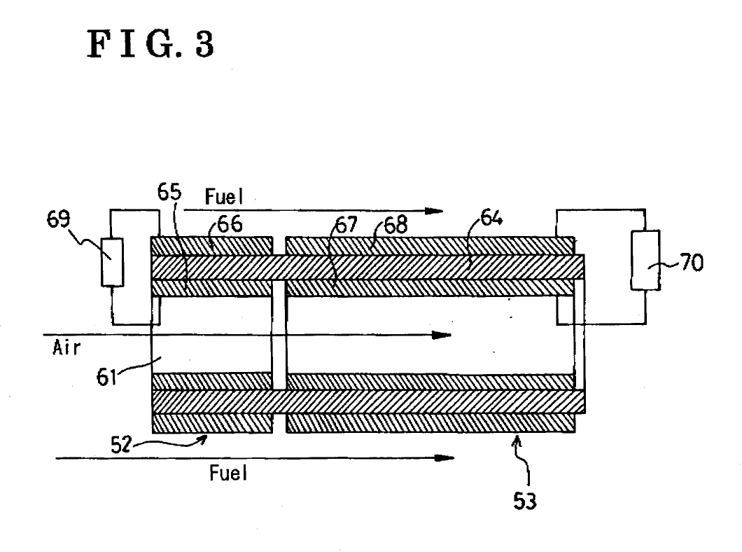

As illustrated in FIG. 3, the electrochemical processing unit 52 and the low temperature SOFC unit 53 shares a low temperature electrolyte 64. The low temperature SOFC unit 53 is made of a solid oxide material such as the ceria—rare earth metal oxide, (CeO₂)_{0.8}(SmO_{1.5})_{0.2}. The electrochemical processing unit 52 is arranged at an axially one side of the low temperature electrolyte 64 and the low temperature SOFC unit 53 is arranged at the axially other side thereof. A first electrode 66 is defined at an outer peripheral side of the low temperature electrolyte 64 at the axially one side and a second electrode 65 is defined at an inner peripheral side thereof. An anode 68 is defined at an outer peripheral side of the low temperature electrolyte 64 at the axially other side and a cathode 67 is defined at an inner peripheral side thereof.

There are clearances defined between the first electrode 66 and the anode 68, and between the second electrode 65 and the cathode 67, respectively, so as not to be electrically connected thereto. The first electrode 66 and the anode 68 are made of Ni/Cerla Cermet, Ni/Ce_{0.8}So_{0.2}O₃. The second electrode 65 and the cathode 67 are made of Sm_{0.5}Sr_{0.5}CoO₃.

The first and second electrodes 66 and 65 are electrically connected to a power source unit 69 via an electric wire, respectively. The anode 68 and the cathode 67 are electrically connected to an outer load 70 via an electric wire, respectively. Electric power terminal of the first electrode 66, the second electrode 65, the anode 68, and the cathode 67 are made of iron chrome alloy, respectively.

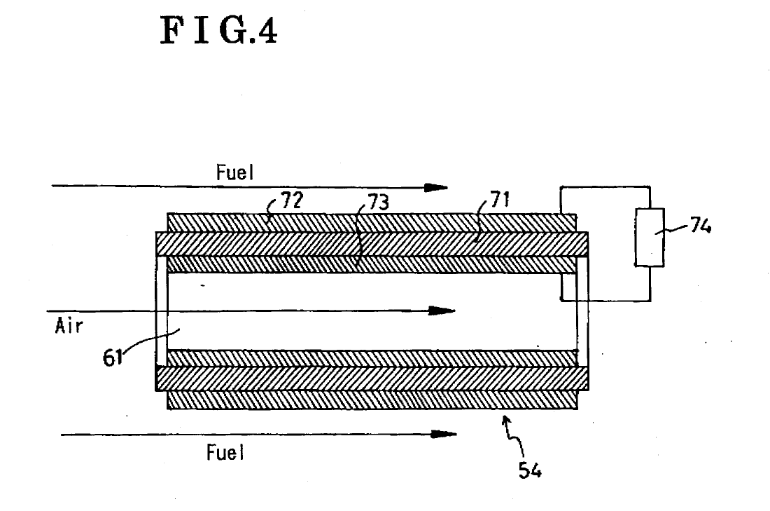

As especially seen in FIG. 4, the high temperature SOFC unit 54 is provided with a high temperature electrolyte 71 which is made of a solid oxide of yttria-stablilzed zirconia (YSZ). An anode 72 is defined at an outer peripheral side of the high temperature electrolyte 71 and a cathode 73 is defined at an inner peripheral side thereof. The anode 72 is made of Ni/Zirconia Cermet and the cathode 93 is made of lanthanum cobalt oxide, La_{0.7}Sr_{0.3}MnO₃.

According to the first embodiment of the present invention, the low temperature electrolyte 64 is bonded with the high temperature electrolyte 71 via glassy ceramics so as to form the cylindrical portion 56. Alternatively, the cylindrical portion 56 can be manufactured by integrally molding a low temperature electrolyte, an insulating material, and a high temperature electrolyte and by sintering all of them.

A mantle portion of each preheating unit 51, the offgas combustor 55, and the exhaust gas passage 59 is made of stainless or inconel. An inner surface thereof is coated with nitride or oxidant such as ceramics, and an outer surface thereof is coated with ceramic wool.

According to the first embodiment of the present invention, methane is applied as the fuel and air is applied as the oxidant. The methane is supplied to the preheating unit 51 and is combusted so as to control the preheating unit 51 at a preferable range of between about 300° C. and about 400° C. The exhaust gas from the preheating unit 51 is emitted from the exhaust gas emitting portion 63 via the exhaust gas passage 59. In this case, the electrochemical processing unit 52, the low temperature SOFC unit 53, and the high temperature SOFC unit 54 are heated by the heat of the exhaust gas and the temperature thereof are increased.

The fuel is evaporated by the heat of the preheating unit 51 and is supplied to the fuel passage 62 of the electrochemical processing unit 52 with a temperature being approximately equal to or greater than 400° C. via the fuel supply conduit 58. The air is heated up by the heat of the preheating unit 51 and is supplied to the oxidant passage 61 with a temperature being approximately equal to or greater than 400° C. via the oxidant supply conduit 57. The electrochemical processing unit 52 is further heated up with a resistance heat generated by the electrochemical potential apply to between the first electrode 66 and the second electrode 65 by the power source 69 so as to positively charge the first electrode 66. Therefore, the actual temperature of the low temperature electrolyte 64 in the electrochemical processing unit 52 reaches the operating temperature which is approximately 500° C.

When the low temperature electrolyte 64 operates at the operating temperature, the oxygen ion is diffused from the second electrode 65 to the first electrode 66 in response to the electric potential apply between the first electrode 66 and the second electrode 65. The fuel supplied to the fuel passage 62 of the electrochemical processing unit 52 is reformed to hydrogen molecules (H₂) and carbon monoxide (CO) in accordance to the cracking reaction and the partially oxidizing reaction and is supplied to the low temperature SOFC unit 53. More specifically, the carbon (C) generated by the cracking reaction is oxidized with the oxygen ion (O²⁻) diffused to the first electrode 66 so as to be reformed as the carbon monoxide (CO) and is supplied to the low temperature SOFC unit 53. The oxygen ion (O²⁻) can be consecutively supplied from the air.

The electricity generating reaction is activated at the low temperature SOFC unit 53 by use of the hydrogen molecules and the carbon monoxide contained in the fuel supplied to the fuel passage 62 and the oxygen contained in the air supplied to the oxidant passage 61. The generated electricity is supplied to the external load 70. Further, the cracking reaction and the partially oxidizing reaction are concurrently activated at the low temperature SOFC unit 53 so as to generate hydrogen molecules and carbon monoxide from the fuel unreacted at the electrochemical processing unit 52. Although the hydrogen and the carbon monoxide can be consumed at the low temperature SOFC unit 53, they are also supplied to the fuel passage 62 of the high temperature SOFC unit 54.

The electricity generating reaction is activated at the high temperature SOFC unit 54 by use of the hydrogen molecules and the carbon monoxide contained in the fuel supplied to the fuel passage 62 and the oxygen contained in the air supplied to the oxidant passage 61. The generated electricity is supplied to the external load 74. The high temperature SOFC unit 54 is supplied not only with the hydrogen molecules and the carbon monoxide, which were not consumed at the low temperature SOFC unit 53, but also the nonreacted fuel, and the vapor and the carbon acid gas, both of which were generated by the electricity generating reaction. Since the high temperature SOFC unit 54 has been heated up at a sufficiently high temperature so that the nonreacted fuel reacts with the vapor or the carbon acid gas and is reformed as hydrogen molecules and carbon monoxide which are utilized for the electricity generating reaction.

The fuel offgas and the oxidant offgas are supplied to the offgas combustor 55 from the fuel passage 62 of the high temperature SOFC unit 54 and the oxidant passage 61 thereof, respectively. The combustible components in the fuel offgas are combusted with the oxygen contained in the air offgas. The exhaust gas from the offgas combustor 55 can be emitted from the exhaust gas emitting portion 63 via the exhaust gas passage 59. In this case, the high temperature SOFC unit 54 is heated with the exhaust gas. When the system is started-up, both actual temperatures of the low temperature SOFC unit 53 and the high temperature SOFC unit 54 have not reached the respective operating temperatures yet. In this case, the great amount of combustible components are contained in the fuel offgas and the combustion heat of the offgas combustor 55 is large. Therefore, the actual temperature of the high temperature SOFC unit 54 is increased and reaches the operating temperature which is approximately equal to or greater than 800° C., thereby the time period of start-up can be effectively cut down. The exhaust gas emitted from the exhaust gas emitting portion 63 is transmitted to a turbo compressor and can be effectively utilized.

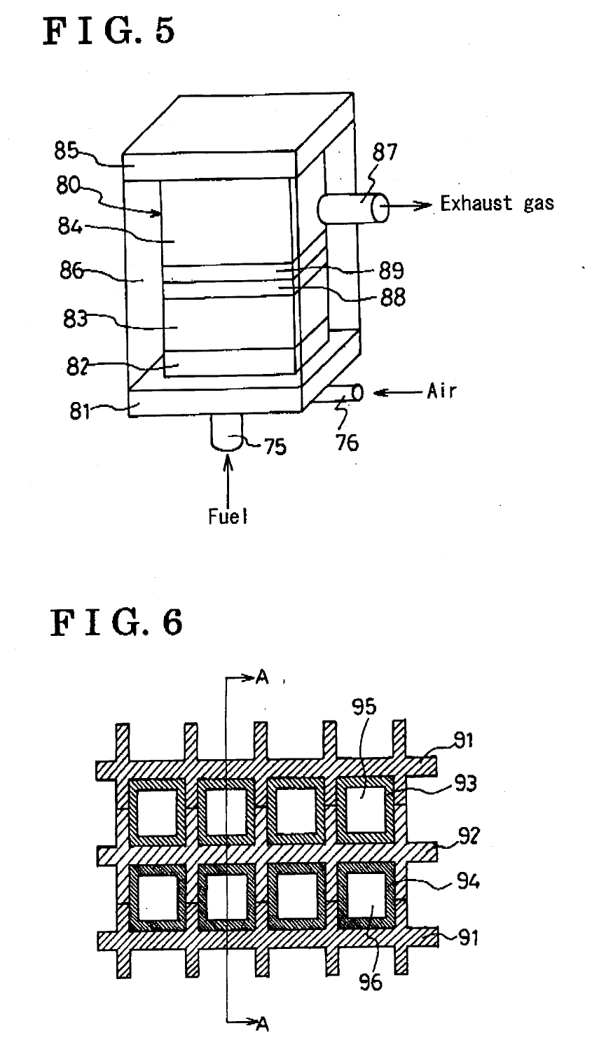

As illustrated in FIG. 5, the SOFC system according to the second embodiment of the preset invention includes a preheating unit 81, an electrochemical processing unit 82, a low temperature SOFC unit 83, a high temperature SOFC unit 84, and an offgas combustor 85. The electrochemical processing unit 82, the low temperature SOFC unit 84, and,the high temperature SOFC unit 85 are of substantially honeycomb structures, respectively, as illustrated in FIG. 6. The low temperature SOFC unit 83 is provided with inter connectors 91 and a second solid oxide electrolytes 92, both of which are arranged interchangeably and are connected to each other. The honeycomb structure of the low temperature SOFC unit 83 is mainly formed with the inter connectors 91 and the second solid oxide electrolytes 92. A second fuel passage 95 is defined between the inter connector 91 and the second solid oxide electrolyte 92 arranged at one side of the inter connector 91 and a second oxidant passage 96 is defined between the inter connector 91 and the second solid oxide electrolyte 92 arranged at the other side. An anode 93 is defined at side surfaces of the inter connector 91 and the second solid oxide electrolyte 92, which define the second fuel passage 95. A cathode 94 is defined at side surfaces of the inter connector 91 and the second solid oxide electrolyte 92, which define the second oxidant passage 96. A fuel cell is configured with the second solid oxide electrolyte 92, the pair of anode 93 and cathode 94, the second fuel passage 95, and the second oxidant passage 96. According to the second embodiment of the present invention, each fuel cell is serially connected to each other via the inter connector 91 and is arranged in a direction orthogonal with the serially connected direction.

The electrochemical processing unit 82 and the high temperature SOFC unit 84 possess substantially the same structure as the low temperature SOFC unit 83. The electrochemical processing unit 82 and the low temperature SOFC unit 83 are respectively provided with an electrochemical material such as (CeO₂)_{0.8}(SmO_{1.5})_{0.2}, the inter connectors 91 made of an iron chrome alloy, first electrodes or the anodes 93, which are respectively made of Ni/Ce_{0.8}Sm_{0.2}O₃, and second electrodes or the cathodes 94, which are respectively made of Sm_{0.5}Sr_{0.5}CoO₃. The inner connectors 91 of the high temperature SOFC unit 84 are made of lanthanum chromate, the electrochemical material thereof is made of yttria-stabilized zirconia (YSZ), first electrodes or the anodes 93 are respectively made of Ni/Zirconia Cermet, and second electrodes or the cathodes 94 are respectively made of La_{0.7}Sr_{0.3}MnO₃. As described above, the SOFC system being of the honeycomb structure according to the second embodiment of the present invention can effectively improve power density outputted therefrom compared with the SOFC system of the cylindrical structure.

The SOFC system according to the second embodiment is provided with an oxidant supply conduit 76 corresponding to the oxidant supply conduit 57 according to the first embodiment, a fuel supply conduit 75 corresponding to the fuel supply conduit 58, an exhaust gas passage 86 corresponding to the exhaust gas passage 59, and an exhaust gas emitting portion 87 corresponding to the exhaust gas emitting portion 63. Structure of each unit of the SOFC system according to the second embodiment and the function thereof are substantially identical to the SOFC system according to the first embodiment, except for that the low temperature SOFC unit 83 is structurally connected to the high temperature SOFC unit 84. Therefore, the structures and functions according to the second embodiment will be omitted. A fuel cell unit 80, which includes the electrochemical processing unit 82, the low temperature SOFC unit 83, and the high temperature SOFC unit 84 is connected to a preheating unit 81 via an insulating plate by means of a glassy gasket.

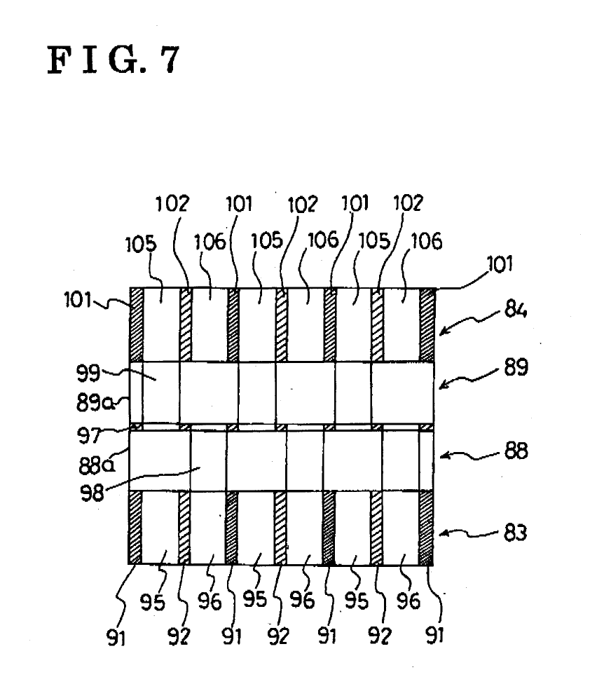

The low temperature SOFC unit 83 and the high temperature SOFC unit 84 are connected to each other via a first gas mixing portion 88 and a second gas mixing portion 89. A cross sectional view of the first gas mixing portion 88, the second gas mixing portion 89, and adjacent portions thereof are illustrated in FIG. 7. The anodes 93 and the cathodes 94 are not illustrated for simplifying the drawing. The first gas mixing portion 88, which is connected to the low temperature SOFC unit 83, includes plural first mixing passages 98, each of which communicates with the second oxidant passages 96. The first mixing passage 98 possesses a substantially cubic structure which is elongated in a vertical direction relative to a sheet illustrating FIG. 7 therein, so that all the air emitted from the second oxidant passages 96 can be supplied to the first mixing passage 98. The first gas mixing portion 88 is surrounded with a mantle wall 88a.

A one side of the second gas mixing portion 89 is connected to the first gas mixing portion 88 and the other side thereof is connected to the high temperature SOFC unit 84. The second gas mixing portion 89 includes plural second mixing passages 99, each of which communicates communicating with a second fuel passage 105 defined in the high temperature SOFC unit 84. The second mixing passage 99 possesses a substantially cubic structure which is elongated in the vertical direction relative to the sheet illustrating FIG. 7 therein. The second gas mixing portion 89 is surrounded with a mantle wall 89a.

The first gas mixing portion 88 is connected to the second gas mixing portion 89 via a member having a wall portion 97. The wall portion 97 is conjunct to the first mixing passage 98 and the second mixing passage 99 so as to close a clearance therebetween, wherein the fuel and the air are not mixed in the first gas mixing portion 88 and the second gas mixing portion 89. The wall portion 97 is formed with a glassy gasket, and the first and second mixing passages 98 and 99 are made of NiCr metal.

The air emitted from the low temperature SOFC unit 83, i.e. the air emitted from the second oxidant passages 96 is supplied to plural second oxidant passages 106 via the first mixing passage 98 and a space other than the second mixing passage 99. The air emitted from the second oxidant passages 96 communicated each other are mixed with each other. The air emitted from the different first mixing passages 98 are mixed at a circumferential portion of the second gas mixing portion 89. Therefore, even if the components contained in the air emitted from each fuel cell in the low temperature unit 83 are not uniform, all the components are uniformed at the first and second gas mixing portions 88 and 89 and are supplied to each fuel cell in the high temperature SOFC unit 84. Therefore, the electricity generating characteristics in the high temperature SOFC unit 84 can be uniformed and the efficiency of the entire fuel cell of the present invention can be improved.

The fuel gas emitted from the low temperature SOFC unit 83, i.e. the fuel gas emitted from the second fuel passages 95 is supplied to the second fuel passages 105 via the space other than the first mixing passage 98 and the second missing passage 99. The fuel gas emitted from the second fuel passages 95 is mixed around a circumferential portion of the first gas mixing portion 88. The mixed fuel gas is supplied to the second fuel passages 105 via the second mixing passage 99. Therefore, even if the components contained in the fuel gas emitted from each cell in the low temperature unit 83 are not uniform, all the components are uniformed at the first gas mixing portion 88 and the second gas mixing portion 89 and are supplied to each fuel cell in the high temperature SOFC unit 84. Therefore, the electricity generating characteristics of the high temperature SOFC unit 84 can be uniformed and the efficiency of the entire fuel cell can be improved.

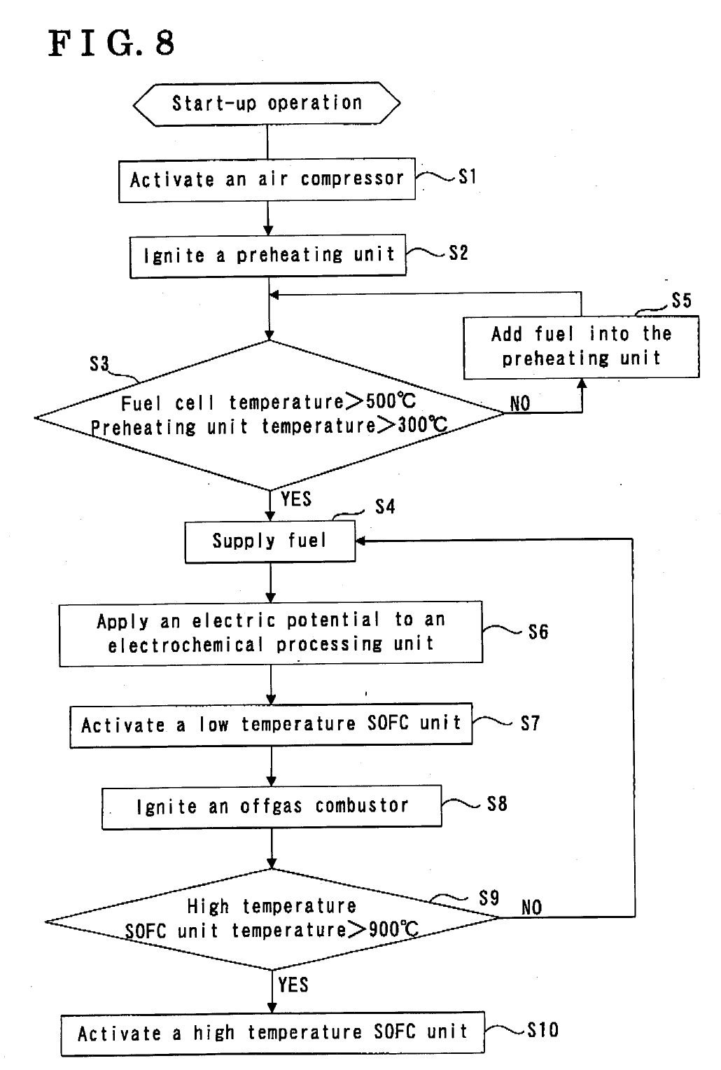

Next, a start-up control of the SOFC system according to the first embodiment is described hereinbelow with reference to FIG. 8. When a start-up switch is turned on, an aim compressor (not illustrated) is activated at step S1 (an oxidant supplying means). The air is supplied to the preheating unit 51 and the oxidant supply conduit 57. The program then proceeds to step S2 (a preheating means) for supplying the combustion fuel to the preheating unit 51 so that the preheating unit 51 is ignited. At step S3 (a second judging means), the control unit 27 according to the present invention judges whether or not the temperature of the low temperature SOFC unit 53 is substantially higher than 500° C. (a predetermined temperature) and whether or not the temperature of the preheating unit 51 is substantially higher than 300° C. (a predetermined temperature), i.e. whether or not an actual temperature of the oxidant and fuel is substantially greater than a predetermined temperature. When the temperature of the low temperature SOFC unit 53 is substantially higher than 500° C. and the temperature of the preheating unit 51 is substantially higher than 300° C., the program proceeds to step 84 (a fuel supplying means). On the other hand, when at least one of the temperature of the low temperature SOFC unit 53 and the temperature of the preheating unit 51 is not substantially higher than each predetermined temperature, the program proceeds to step S5, wherein the combustion fuel is additionally supplied to the preheating unit 51 and the program returns to step S3 for controlling each temperature of the low temperature SOFO unit 53 and the preheating unit 51 to meet the predetermined temperature level.

At step S4, the fuel is supplied to the electrochemical processing unit 52 via the fuel supply conduit 58. At step S6 (an electric potential applying means), the electric potential is applied to the electrochemical processing unit 52. At step S7 (a low temperature SOFC unit activating means), the low temperature SOFC unit 53 is activated and outputs electricity to the outside. At step S8 (an offgas combusting means), the offgas combustor 55 is ignited. The program then proceeds to step S9 (a first judging means) to judge whether or not the temperature of the high temperature SOFC unit 54 is substantially higher than 900° C. When the temperature of the high temperature SOFC unit 54 is substantialy equal to or smaller than 900° C., the program returns to step S4. On the other hand, when the temperature of the high temperature SOFC unit 54 is substantially higher than 900° C., the program proceeds to step S10 (a high temperature SOFC unit activating means) so as to activate the high temperature SOFC unit 54. The SOFC system according to the first embodiment is then operated under the stationary condition.

A start-up control of the SOFC system according to the second embodiment is performed in the same manner as the first embodiment described above. Therefore, the description thereof will be omitted for simplifying the description.

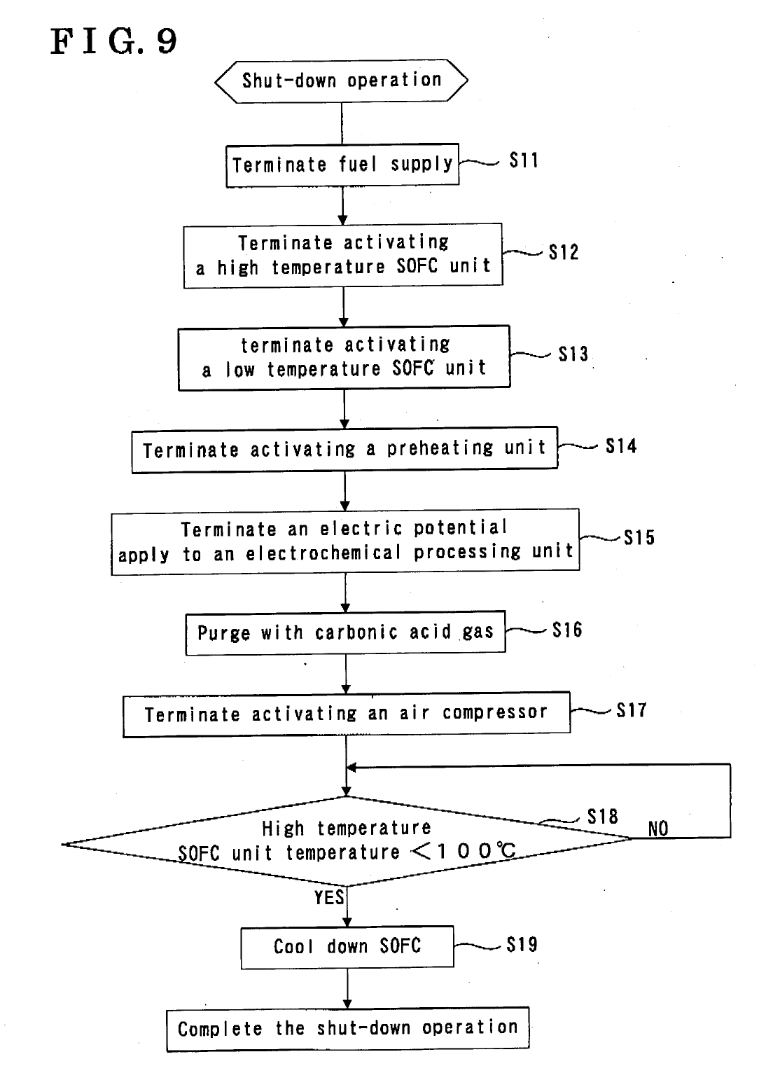

Next, a shut-down control of the SOFC system according to the second embodiment is described hereinbelow with reference to FIG. 9. When a shut-down signal of the SOFC system is inputted, the fuel supply is terminated at step S11 (a first terminating means). At step S12 (a second terminating means), the activating operation of the high temperature SOFC unit 54 is then terminated. At step S13 (a third terminating means), the activating operation of the low temperature SOFC unit 53 is then terminated. At step S14 (a fourth terminating means), the activating operation of the preheating unit 51 is terminated. At step S15 (a fifth terminating means), the electric potential apply to the electrochemical processing unit 52 is terminated. At step S16 (a purging method), carbonic acid gas is supplied to the fuel passage 62 so as to purge the fuel passage 62. At step S17 (a sixth terminating means), the activating operation of the air compressor is terminated. The program then proceeds to step S18 (a third judging means) for judging whether or not the temperature of the high temperature SOFC unit 54 is substantially lower than 100° C. When the temperature thereof is substantially lower than 100° C., the program proceeds to step S19 (a cooling down means) for cooling down the entire fuel cell. The operation of the SOFC system according to the first embodiment is then terminated.

The shut-down control of the SOFC system according to the second embodiment is performed in the same manner as the first embodiment described above. Therefore, the description thereof will be omitted for simplifying the description.

The principles, preferred embodiments and mode of operation of the present invention have been described in the foregoing specification. However, the invention which is intended to be protected is not to be construed as limited to the particular embodiments disclosed. Further, the embodiments described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. A solid oxide fuel cell system comprising:
an electrochemical processing unit including:
a first solid oxide electrolyte;
a first electrode defined at one side of the first solid oxide electrolyte;
a first fuel passage for supplying fuel to the first electrode;
a second electrode defined at the other side of the first solid oxide electrolyte;
a first oxidant passage for supplying oxidant to the second electrode; and
a power source unit capable of applying an electric potential to between the first electrode and the second electrode so as to positively charge the first electrode; and
a solid oxide fuel cell having an electricity generating unit including:
a second solid oxide electrolyte;
an anode defined at one side of the second solid oxide electrolyte;
a second fuel passage supplying the fuel to the anode;
a cathode defined at the other side of the second solid oxide electrolyte; and
a second oxidant passage for supplying the oxidant to the cathode, wherein the fuel emitted from the first fuel passage is supplied to the second fuel passage.

2. A solid oxide fuel cell system according to claim 1, wherein the solid oxide fuel cell is provided with plural electricity generating units, the electricity generating unit positioned at an upstream side for the fuel supply operates at a lower temperature than the electricity generating unit positioned at a downstream side for the fuel supply.

3. A solid oxide fuel cell system according to claim 2, wherein a mixing portion is disposed between the plural electricity generating units for mixing gas emitted from plural cells in the electricity generating unit positioned at the upstream side and for supplying the mixed gas to the electricity generating unit positioned at the downstream for the fuel cell.

4. A solid oxide fuel cell system according to claim 2, wherein a mixing portion is disposed between the plural electricity generating units for mixing the fuel emitted from the second fuel passages included in respective plural cells in the electricity generating unit positioned at the upstream side and supplying the mixed fuel to the electricity generating unit positioned at the downstream, and for mixing the oxidant emitted from the second oxidant passages included in the respective plural cells and supplying the mixed oxidant to the electricity generating unit positioned at the downstream.

5. A solid oxide fuel cell system according to claim 1, wherein the electric potential is applied to between the first electrode and the second electrode for positively charging the first electrode of the electrochemical processing unit when the solid oxide fuel cell system is started-up.

6. A solid oxide fuel cell system according to claim 5, further comprising:
a carbon deposition detecting unit for detecting a carbon deposited onto the first electrode, wherein the electric potential is applied to between the first electrode and the second electrode for positively charging the first electrode when the carbon deposition is detected by the carbon deposition detecting unit.

7. A solid oxide fuel cell system according to claim 2, wherein the electricity generating unit positioned at the upstream side is operated prior to the electricity generating unit positioned at the downstream side.

8. A solid oxide fuel cell system according to claim 1, wherein the solid oxide fuel cell is provided with plural electricity generating units positioned in serial relative to each other, the electricity generating unit which is positioned at an upstream for the fuel supply and is arranged most adjacent to the electrochemical processing unit among the plural electricity generating units operates at a relatively low temperature, and the operating temperatures of the respective plural electricity generating units are increased in accordance with being away from the upstream side for the fuel supply.

9. A solid oxide fuel cell system according to claim 8, wherein the relatively low temperature is a temperature for predominantly activating a cracking reaction, and a reforming reaction is more predominantly activated in accordance with being away from the upstream side for the fuel supply.

10. A solid oxide fuel cell system according to claim 1, further comprising:
a preheating unit for preheating the fuel to be supplied to the electrochemical processing unit and the oxidant to be supplied to the electrochemical processing unit.

11. A solid oxide fuel cell system according to claim 1, further comprising:
an offgas combustor for combusting a combustible fuel contained in a fuel gas emitted from the solid oxide fuel cell with oxygen remaining in an oxidant gas emitted therefrom, wherein combustion heat in the offgas combustor is transmitted to the solid oxide fuel cell.

12. A method for controlling a solid oxide fuel cell system comprising:
an oxidant supplying means for supplying oxidant to an electrochemical processing unit and a solid oxide fuel cell;
a fuel supplying means for supplying fuel to the electrochemical processing unit and the solid oxide fuel cell;
an electric potential applying means for applying an electric potential to the electrochemical processing unit, the electric potential applied to between a first electrode of the electrochemical processing unit and a second electrode of the electrochemical processing unit so as to positively charge the first electrode;
a low temperature SOFC unit activating means for activating a low temperature SOFC unit of the solid oxide fuel cell;
a first judging means for judging whether or not an actual temperature of a high temperature SOFC unit of the solid oxide fuel cell is substantially greater than a predetermined temperature; and
a high temperature SOFC unit activating means for activating the high temperature SOFC unit when the actual temperature of the high temperature SOFC unit is judged to be substantially greater than the predetermined temperature.

13. A method for controlling a solid oxide fuel cell system according to claim 12, further comprising;
a preheating means for preheating the oxidant to be supplied to the electrochemical processing unit and the fuel to be supplied to the electrochemical processing unit;
a second judging means for judging whether or not an actual temperature of the low temperature SOFC unit is substantially greater than a predetermined temperature and whether or not an actual temperature of the oxidant and fuel is substantially greater than a predetermined temperature, wherein the low temperature SOFC unit is activated after the electric potential is applied to between the first electrode of the electrochemical processing unit and the second electrode thereof so as to positively charging the first electrode when the actual temperature of the low temperature SOFC unit is judged to be substantially greater than the predetermined temperature and the actual temperature of the oxidant and fuel is judged to be substantially greater than the predetermined temperature.

14. A method for controlling a solid oxide fuel cell according to claim 13, wherein the fuel is additionally supplied for controlling the actual temperature of the low temperature SOFC unit to be substantially greater than the predetermined temperature and for controlling the actual temperature of the oxidant and fuel to be substantially greater than the predetermined temperature when at least one of the actual temperatures of the low temperature SOFC unit and the fuel and oxidant is not judged to be substantially greater than the predetermined temperature.

15. A method for controlling a solid oxide fuel cell according to claim 14, further comprising:
an offgas combusting means for combusting a combustible fuel contained in a fuel gas emitted from the solid oxide fuel cell with oxygen remaining in an oxidant gas emitted therefrom, wherein combustion heat generated by combusting the combustible fuel with the oxygen is transmitted to the solid oxide fuel cell.

16. A method for controlling a solid oxide fuel cell according to claim 15, further comprising:
a first terminating means for terminating the fuel supply executed by the fuel supplying means:
a second terminating means for terminating the activating operation of the high temperature SOFC unit executed by the high temperature SOFC unit activating means;
a third terminating means for terminating the activating operation of the low temperature SOFC unit executed by the low temperature SOFC unit activating means;
a fourth terminating means for terminating the fuel and oxidant combustion executed by the offgas combusting means;
a fifth terminating means for terminating the electric potential apply to between the first electrode of the electrochemical processing unit and the second electrode thereof executed by the electric potential applying means;
a purging method for purging with carbonic acid gas;
a sixth terminating means for terminating the oxidant supply executed by the oxidant supplying means;
a third judging means for judging whether or not the actual temperature of the high temperature SOFC unit is substantially lower than a predetermined temperature; and
a cooling down means for cooling down the solid oxide fuel cell when the actual temperature of the high temperature SOFC unit is judged to be substantially lower than the predetermined temperature.
